(19) United States
(12) Patent Application Publication
(10) Pub. No.: US 2013/0067458 A1
(43) Pub. Date: Mar. 14, 2013

(54) APPLICATION SITE OF ORIGIN REFERENCE SCHEME

(71) Applicants: David L. Risney, Redmond, WA (US); Justin Y. Kwak, Redmond, WA (US); Shantanu S. Prasade, (US)

(72) Inventors: David L. Risney, Redmond, WA (US); Justin Y. Kwak, Redmond, WA (US); Shantanu S. Prasade, (US)

(21) Appl. No.: 13/230,361

(22) Filed: Sep. 12, 2011

(51) Int. Cl. G06F 15/16; G06F 9/445

(52) U.S. Cl. 717/175; 709/217

(57) ABSTRACT

In embodiments of an application site of origin reference scheme, an application package can be installed on a computing device, and the application package includes an application authored in a mark-up language and executed from script files. The script files of the application can be executed at the computing device, and an application user interface can be displayed in a Web browser. Resources can then be referenced for use with the application, where the resources are referenced with site of origin references that are unique to the application package and agnostic to the file system of the computing device.

### BACKGROUND

Computing devices are implemented to execute various types of software applications. Traditionally, a developer uses a programming language to write source files of software code that is compiled into an executable software application. The executable software application can then be loaded into memory of a computing device and run by one or more processors of the computing device. More recently, modern applications, also referred to as web applications or packaged applications, are developed using Web-based technologies that are typically used for web page development, such as HTML, CSS, and other markup languages, along with scripting languages. Web applications developed with a markup language and composed of one or more script files can be executed by loading the files into a hosting application and/or environment (e.g. a Web browser and/or script engine). The script files are then processed in context with the hosting application to execute the web application. In various implementations, a Web application can be downloaded from a network service or other remote location, installed locally on a computing device, and then the script files of the web application executed by the computing device when initiated by a user.

A locally installed web application can be developed to acquire runtime data and/or other script files from remote locations and/or network services during runtime, which adds flexibility to the executing application. A web application can participate in the Web ecosystem (referring to the World Wide Web) while leveraging local resources on the computing device that runs the web application. A same origin policy relates to access security and permits a script of a web application to access methods and properties of other script files of the web application, but restricts access to other non-related script files. In the Web ecosystem, the site of origin is an RFC3986 compliant URL (uniform resource locator) that is used to identify a resource. This reference is used for various security related purposes in a variety of Web browser features, such as for an XML HTTP Request, for Web storage, and other features. The site of origin is the application identifier of the Web, and a web application requires that a Web compliant site of origin also facilitates local system context.

Developers face site of origin problems with web applications, both during development and when executed on a computing device. For example, a web application can include resources, such as scripts, music files, video files, graphic files, and so on. Typically, not all of the resources are loaded when the web application launches, but rather, the resources are loaded as-needed during runtime of the application. However, to request and retrieve the resources, the web application needs to reference the resources in a way that is agnostic of the computing device on which the resource will be deployed. Further, different resources in an application package may be identified with the same name, such as logo.jpg or index.html, and the resources need to be distinguished, particularly for a web application that takes a dependency on other web applications that have resources with the same names.

### SUMMARY

This Summary introduces simplified concepts of an application site of origin reference scheme, and the concepts are further described below in the Detailed Description and/or shown in the Figures. This Summary should not be considered to describe essential features of the claimed subject matter, nor used to determine or limit the scope of the claimed subject matter.

An application site of origin reference scheme is described. In embodiments, an application package can be installed on a computing device, and the application package includes an application authored in a mark-up language and executed from script files. The script files of the application can be executed at the computing device, and an application user interface can be displayed in a Web browser. Resources can then be referenced for use with the application, where the resources are referenced with site of origin references that are unique to the application package and agnostic to the file system of the computing device.

In other embodiments, the site of origin references are further agnostic of a URL schema utilized by the Web browser on the computing device to navigate Web content, and the site of origin references are not dependent on a URL schema supported by a Web server. The Web browser can utilize the site of origin references to reference local resources included with the application package on the computing device and/or to reference remote resources that are part of the application package and one of located remote to the computing device or have a different host security basis. In embodiments, the site of origin references are part of a site of origin reference scheme that includes local site of origin references that are URL compliant to reference the local resources included with the application package on the computing device. The site of origin reference scheme also includes remote site of origin references that are URL compliant to reference remote resources that are one of located remote to the computing device or are maintained on the computing device and have a different host security basis.

### BRIEF DESCRIPTION OF THE DRAWINGS

Embodiments of an application site of origin reference scheme are described with reference to the following Figures. The same numbers may be used throughout to reference like features and components that are shown in the Figures:

FIG. 1 illustrates an example system in which embodiments of an application site of origin reference scheme can be implemented.

FIG. 2 illustrates example method(s) of an application site of origin reference scheme in accordance with one or more embodiments.

FIG. 3 illustrates various components of an example device that can implement embodiments of an application site of origin reference scheme.

### DETAILED DESCRIPTION

Embodiments of an application site of origin reference scheme are described. An application package can include one or more web applications that are developed using Web-based technologies, such as HTML, CSS, and other markup languages, along with scripting languages. A web application is also commonly referred to as a modern application or packaged application, and can be installed on a computing device. Packaged content and script files of the web application can be processed in context with a hosting application (e.g., a Web browser application and/or script engine) to execute the web application at the computing device.

In embodiments, a site of origin reference scheme includes local site of origin references and remote site of origin references that are RFC3986 compliant with URL site of origin policies for use with web applications. When a web application needs to present a site of origin, the Web browser application (or other hosting application) can use the local site of origin references and/or the remote site of origin references of the new site of origin reference scheme which are broadly accepted by Web servers. The site of origin references are unique to an application package that includes a web application, and the site of origin references distinguish between web application local resources on a local computing device and remote resources, such as resources that are located remote to the computing device or are maintained on the computing device and have a different host security basis for host enforcement. Additionally, the site of origin references are agnostic to the file system of a computing device and agnostic of a URL schema utilized by a Web browser application on a computing device to navigate Web content. Further, the site of origin references are not dependent on a URL schema that needs to be supported by a Web server.

While features and concepts of an application site of origin reference scheme can be implemented in any number of different devices, systems, networks, environments, and/or configurations, embodiments of an application site of origin reference scheme are described in the context of the following example devices, systems, and methods.

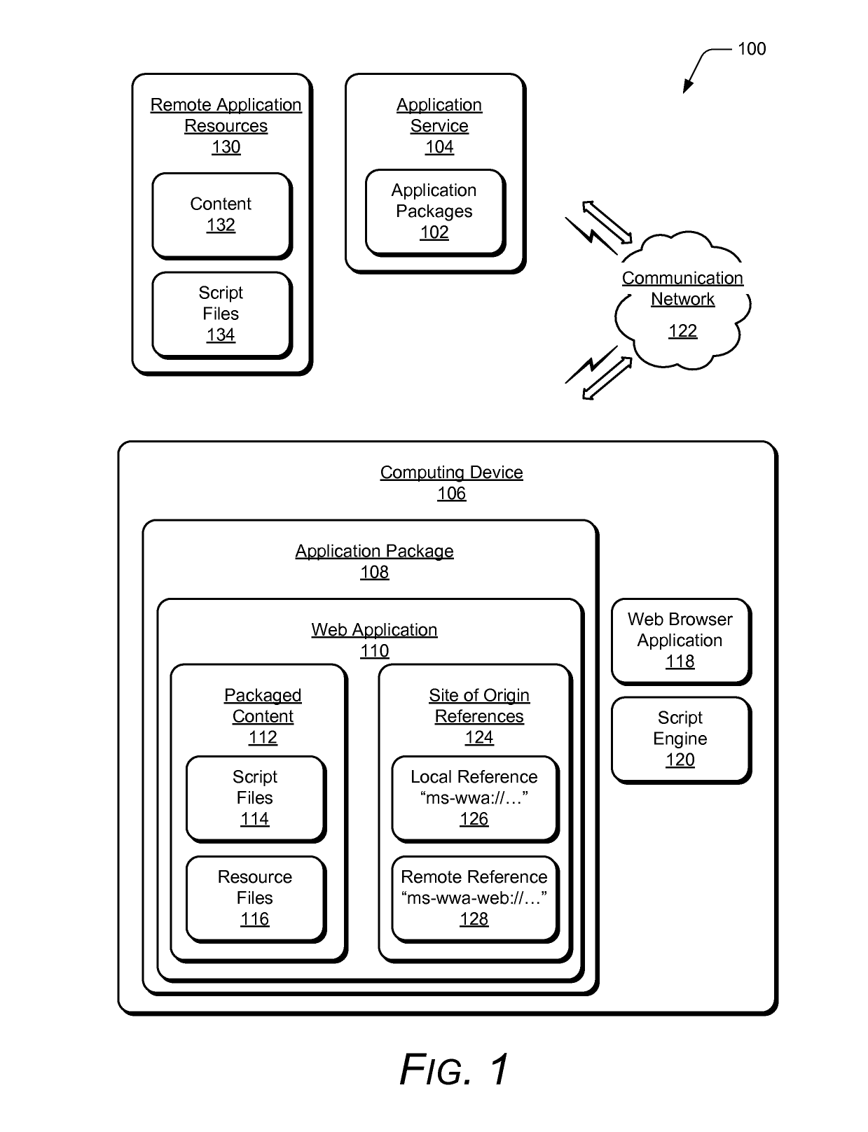

FIG. 1 illustrates an example system 100 in which various embodiments of an application site of origin reference scheme can be implemented. The example system includes application packages 102, such as may be developed and maintained at an application service 104. An application package can include one or more web applications that are developed using Web-based technologies, such as HTML, CSS, and other markup languages, along with scripting languages. A web application is also commonly referred to as a modern application, packaged application, or hostable application when downloaded and installed on a computing device.

The example system 100 also includes a computing device 106 that can download an application package 108 from the application service 104, and install a web application 110 from the application package on the computing device. The web application includes packaged content 112, such as script files 114 and/or resource files 116 utilized to instantiate the web application. The computing device also includes a Web browser application 118 and/or a script engine 120 via which a user interface of the web application is generated for display and user interaction with the application. The packaged content, to include the script files and the resource files, can be processed in context with the hosting application (e.g., the Web browser application and/or script engine) to execute the web application.

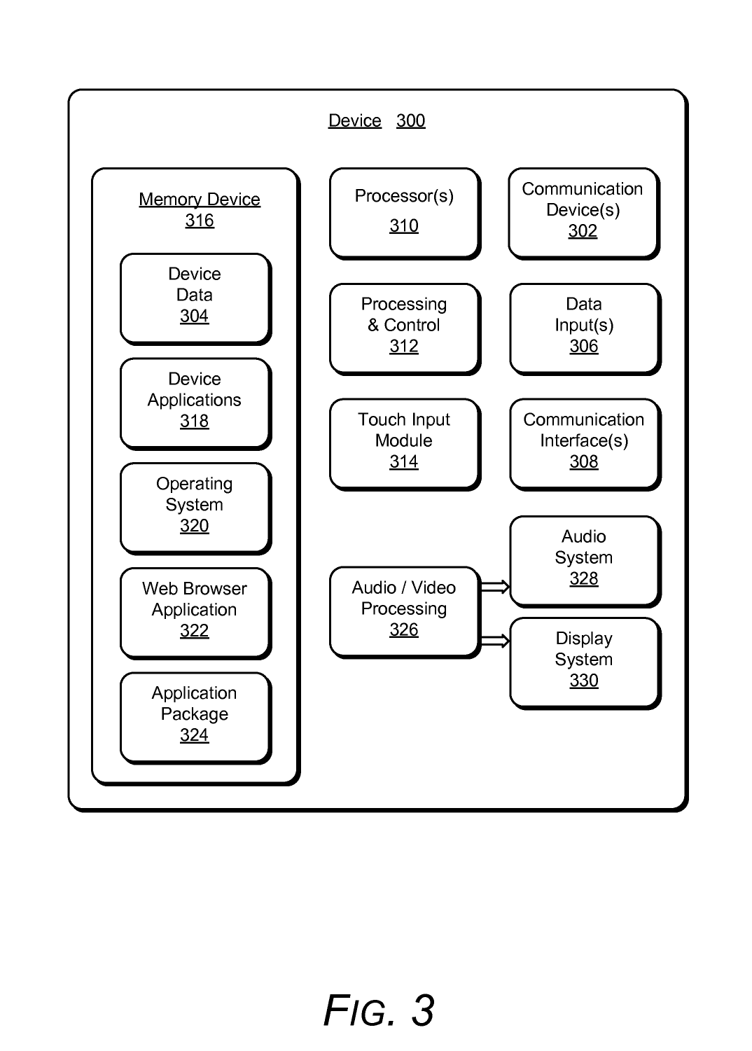

The computing device is representative of any type of fixed or mobile device that may be configured to download an application package, and install and execute a web application. For example, the computing device can be implemented in any form of a consumer, computer, portable, communication, navigation, media playback, entertainment, gaming, tablet, and/or electronic device. Additionally, any of the computing devices can be implemented with various components, such as one or more processors and memory devices, as well as with any combination of differing components as further described with reference to the example electronic device shown in FIG. 3.

Any of the services, servers, and devices can communicate via a communication network 122, which can be implemented to include wired and/or wireless networks. The communication network can also be implemented using any type of network topology and/or communication protocol, and can be represented or otherwise implemented as a combination of two or more networks, to include IP-based networks and/or the Internet. The communication network may also include mobile operator networks that are managed by mobile operators, such as a communication service provider, cell-phone provider, and/or Internet service provider.

In embodiments, the web application 110 of the application package 108 at computing device 106 includes site of origin references 124 that are used to reference resources for use with the web application 110. The web application is an entity that includes the scheme for the site of origin references. The site of origin references are unique to the application package, as well as agnostic to the file system of the computing device and agnostic of a URL schema utilized by the Web browser application 118 on the computing device to navigate Web content. Further, the site of origin references are not dependent on a URL schema that needs to be supported by a Web server. The site of origin references are part of a site of origin reference scheme that includes local site of origin references 126 and remote site of origin references 128 that are URL compliant to reference resources for use with the web application.

The Web browser application can utilize the local site of origin references to reference the local resources (e.g., the packaged content 112, to include the script files 114 and/or the resource files 116) included with the application package on the computing device. The remote site of origin references can be utilized to reference remote application resources 130, such as other application content 132 and/or script files 134. The remote application resources are part of the same application package 108, but may be located at a remote device to the computing device, or may be located on the computing device 106, but have a different host security basis for host enforcement.

In an implementation, the local site of origin references 126 are designated “ms-wwa://” to reference the local resources (e.g., the packaged content 112, to include the script files 114 and the resource files 116) on the computing device 106. The remote site of origin references 128 are designated “ms-wwa-web://” to reference the remote application resources 130 that are either located remote to the computing device, or may be located on the computing device 106, but have a different host security basis for host enforcement. In this convention, the schema names “ms-wwa” or “ms-wwa-web” are used rather than a conventional HTTP for URLs that are currently used to reference both local and remote resources. Any other type of naming or identifying conventions may also be implemented for the site of origin references in the site of origin reference scheme. A local site of origin reference “ms-wwa://” in the scheme is utilized only within the web application host, and is not used by other processes or applications to start another process or application. Further, the site of origin references scheme described herein avoids name collisions, as there is currently no registered or unregistered schemes with a similar identifying convention.

In embodiments, the local site of origin references 126 are implemented with the syntax: ms-wwa://[hostname]/[percent-encoded resource path](?[optional query])(#[optional fragment]), and the remote site of origin references 128 are implemented with the syntax: ms-wwa-web://[hostname]/[percent-encoded resource path](?[optional query])(#[optional fragment]). The [hostname] refers to an application package as the web-encoded package family moniker, such as the application package 108 at computing device 106, and the site of origin reference includes the resource name. For example, a local site of origin reference to a local resource for a logo image at the computing device 106 for the web application 110 may be “ms-wwa://application110/logo.jpg”. In this convention, a logo image for a first web application can be distinguished from a logo image for a second web application, particularly if the first web application takes a dependency on the second web application, such as if both web applications are installed on the computing device.

The authority component of a conventional URI (uniform resource identifier) includes the username, password, hostname, and port. In the site of origin reference scheme described herein, the username, password, and port components are not used for the site of origin references “ms-wwa://” and “ms-wwa-web://”. In implementations, the hostname of the site of origin references 124 includes the application package name followed by an underscore (“_”), followed by the base 16 encoded hash of the publisher name. If the result contains non-US-ASCII characters, then it can be encoded using the IDN To Ascii function defined in RFC3490.

The path of a “ms-wwa://” site of origin reference is the path to a desired resource relative to the root of the application package with each path segment delimited by a forward slash. The names of the files and directories that appear in each path segment have all non-unreserved characters (i.e., unreserved as defined in RFC3986 Appendix A) first converted to UTF-8 byte sequence and then percent-encoded (i.e., as defined in RFC3986). The path may only be used to reference resources within the an application package or in dependency packages, so that the host will only search the current application package and other application packages that have been declared as a dependency package for matching resources. If there is more than one matched resource (e.g., index.html or logo.jpg), then the current application package is first by default and then the host will search through any dependency packages in the order that they are listed and return the first match. The query and fragment components are optional in the site of origin references. They may be provided but are not used for resolution of an “ms-wwa://” reference. Rather, a query or fragment component may be consumed by a referenced resource.

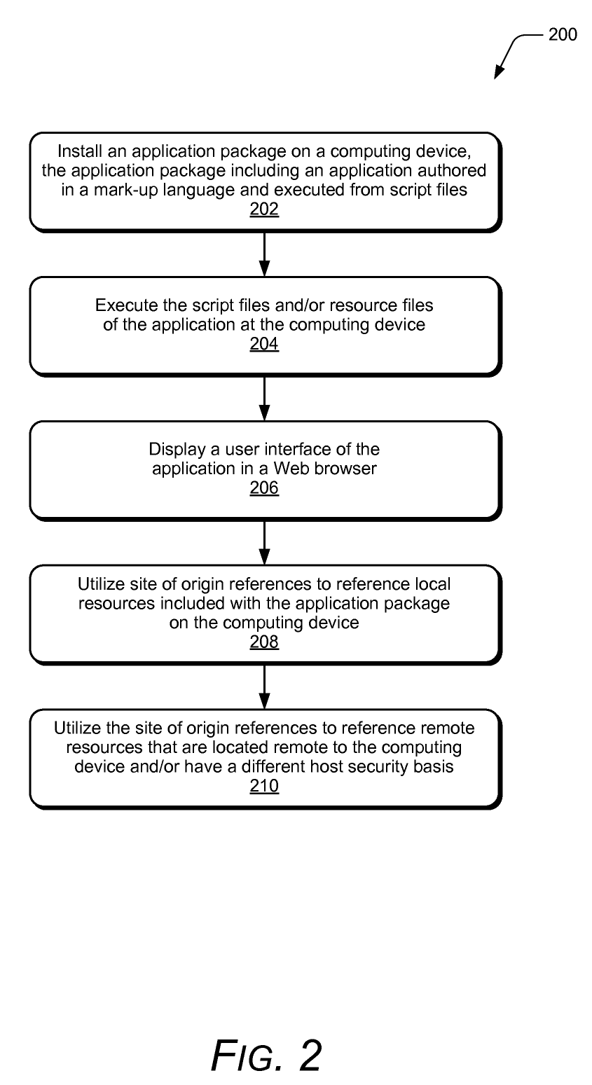

Example method 200 is described with reference to FIG. 2 in accordance with one or more embodiments of an application site of origin reference scheme. Generally, any of the services, functions, methods, procedures, components, and modules described herein can be implemented using software, firmware, hardware (e.g., fixed logic circuitry), manual processing, or any combination thereof. A software implementation represents program code that performs specified tasks when executed by a computer processor. The example methods may be described in the general context of computer-executable instructions, which can include software, applications, routines, programs, objects, components, data structures, procedures, modules, functions, and the like. The program code can be stored in one or more computer-readable storage media devices, both local and/or remote to a computer processor. The methods may also be practiced in a distributed computing environment by multiple computer devices. Further, the features described herein are platform-independent and can be implemented on a variety of computing platforms having a variety of processors.

FIG. 2 illustrates example method(s) 200 of application site of origin reference scheme. The order in which the method blocks are described are not intended to be construed as a limitation, and any number of the described method blocks can be combined in any order to implement a method, or an alternate method.

At block 202, an application package is installed on a computing device, and the application package includes an application authored in a mark-up language and executed from script files. For example, the computing device 106 (FIG. 1) installs the web application 110 from the application package 108 on the computing device. The web application includes packaged content 112, such as script files 114 and/or resource files 116 utilized to instantiate the web application.

At block 204, the script files and/or the resource files of the application are executed at the computing device and, at block 206, an application user interface is displayed in a Web browser. For example, the computing device 106 includes the Web browser application 118 and/or the script engine 120 via which a user interface of the web application 110 is generated for display and user interaction with the web application. The packaged content 112, to include the script files 114 and the resource files 116, can be processed in context with the hosting application (e.g., the Web browser application and/or script engine) to execute the web application.

At block 208, site of origin references are utilized to reference local resources included with the application package on the computing device. Similarly, at block 210, the site of origin references are utilized to reference remote resources that are located remotely or considered remote due to having a different host security basis. For example, the web application 110 of the application package 108 at computing device 106 includes the site of origin references 124 that are used to reference resources for use with the web application. The site of origin references are unique to the application package, as well as agnostic to the file system of the computing device and agnostic of a URL schema utilized by the Web browser application 118 on the computing device to navigate Web content. Further, the site of origin references are not dependent on a URL schema that needs to be supported by a Web server.

The site of origin references are part of a site of origin reference scheme that includes the local site of origin references 126 and the remote site of origin references 128 that are URL compliant to reference resources for use with the web application. The local site of origin references are utilized to reference the local resources included with the application package on the computing device. The remote site of origin references are utilized to reference remote application resources 130, such as other application content 132 and/or script files 134.

FIG. 3 illustrates various components of an example device 300 that can be implemented as any of the devices, servers, or services implemented by devices, described with reference to the previous FIGS. 1-2. In embodiments, the device may be implemented as any one or combination of a fixed or mobile device, in any form of a consumer, computer, portable, user, communication, phone, navigation, television, appliance, gaming, media playback, and/or electronic device. The device may also be associated with a user (i.e., a person) and/or an entity that operates the device such that a device describes logical devices that include users, software, firmware, hardware, and/or a combination of devices.

The device 300 includes communication devices 302 that enable wired and/or wireless communication of device data 304, such as received data, data that is being received, data scheduled for broadcast, data packets of the data, etc. The device data or other device content can include configuration settings of the device, media content stored on the device, and/or information associated with a user of the device. Media content stored on the device can include any type of audio, video, and/or image data. The device includes one or more data inputs 306 via which any type of data, media content, and/or inputs can be received, such as user-selectable inputs and any other type of audio, video, and/or image data received from any content and/or data source.

The device 300 also includes communication interfaces 308, such as any one or more of a serial, parallel, network, or wireless interface. The communication interfaces provide a connection and/or communication links between the device and a communication network by which other electronic, computing, and communication devices communicate data with the device.

The device 300 includes one or more processors 310 (e.g., any of microprocessors, controllers, and the like) which process various computer-executable instructions. Alternatively or in addition, the device can be implemented with any one or combination of software, hardware, firmware, or fixed logic circuitry that is implemented in connection with processing and control circuits which are generally identified at 312. In embodiments, the device 300 can also include a touch input module 314 that is implemented to recognize touch input sensor data. Although not shown, the device can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

The device 300 also includes one or more memory devices 316 (e.g., computer-readable storage media) that enable data storage, such as random access memory (RAM), non-volatile memory (e.g., read-only memory (ROM), flash memory, etc.), and a disk storage device. A disk storage device may be implemented as any type of magnetic or optical storage device, such as a hard disk drive, a recordable and/or rewriteable disc, and the like. The device may also include a mass storage media device.

Computer readable media can be any available medium or media that is accessed by a computing device. By way of example, and not limitation, computer readable media may comprise storage media and communication media. Storage media include volatile and non-volatile, removable and non-removable media implemented in any method or technology for storage of information, such as computer-readable instructions, data structures, program modules, or other data. Storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by a computer.

Communication media typically embody computer-readable instructions, data structures, program modules, or other data in a modulated data signal, such as carrier wave or other transport mechanism. Communication media also include any information delivery media. A modulated data signal has one or more of its characteristics set or changed in such a manner as to encode information in the signal. By way of example, and not limitation, communication media include wired media such as a wired network or direct-wired connection, and wireless media such as acoustic, RF, infrared, and other wireless media.

A memory device 316 provides data storage mechanisms to store the device data 304, other types of information and/or data, and various device applications 318 that can be implemented as computer-executable instructions, such as a software application, and executed by the one or more processors. For example, an operating system 320 can be maintained as a software application with the memory device and executed on the processors. The device applications may also include a device manager, such as any form of a control application, software application, signal processing and control module, code that is native to a particular device, a hardware abstraction layer for a particular device, and so on. In this example, the device applications 318 include a Web browser application 322 and an application package 324 that implement embodiments of an application site of origin reference scheme as described herein.

The device 300 also includes an audio and/or video processing system 326 that generates audio data for an audio system 328 and/or generates display data for a display system 330. The audio system and/or the display system may include any devices that process, display, and/or otherwise render audio, video, display, and/or image data. Display data and audio signals can be communicated to an audio device and/or to a display device via an RF (radio frequency) link, S-video link, composite video link, component video link, DVI (digital video interface), analog audio connection, or other similar communication link. In implementations, the audio system and/or the display system are external components to the device. Alternatively, the audio system and/or the display system are integrated components of the example device, such as an integrated touch-screen display.

Although embodiments of an application site of origin reference scheme have been described in language specific to features and/or methods, the appended claims are not necessarily limited to the specific features or methods described. Rather, the specific features and methods are disclosed as example implementations of an application site of origin reference scheme.

1. A computing device, comprising:
at least a memory and processor configured to implement an application authored in a mark-up language and displayed in a Web browser, the application included in an application package that is installed on the computing device; and
site of origin references configured to reference resources for use with the application, the site of origin references unique to the application package and agnostic to a file system of the computing device.

2. A computing device as recited in claim 1, wherein the site of origin references are further agnostic of a URL schema utilized by the Web browser on the computing device to navigate Web content.

3. A computing device as recited in claim 1, wherein the site of origin references are not dependent on a URL schema supported by a Web server.

4. A computing device as recited in claim 1, wherein the resources include a local resource that is referenced within the application package on the computing device, and a remote resource that is part of the application package and one of located remote to the computing device or has a different host security basis.

5. A computing device as recited in claim 1, wherein the Web browser is configured to utilize the site of origin references to reference local resources included with the application package on the computing device.

6. A computing device as recited in claim 1, wherein the Web browser is configured to utilize the site of origin references to reference remote resources that are one of located remote to the computing device or are maintained on the computing device and have a different host security basis.

7. A computing device as recited in claim 1, further comprising a site of origin reference scheme that includes the site of origin references, the site of origin reference scheme including:
local site of origin references that are URL compliant to reference local resources included with the application package on the computing device; and
remote site of origin references that are URL compliant to reference remote resources that are part of the application package and one of located remote to the computing device or have a different host security basis.

8. A computing device as recited in claim 7, wherein:
the local site of origin references are designated ms-wwa:// to reference the local resources on the computing device; and
the remote site of origin references are designated ms-wwa-web:// to reference the remote resources.

9. A computer-implemented method, comprising:
installing an application package on a computing device, the application package including an application authored in a mark-up language and executed from script files;
executing the script files of the application at the computing device and displaying an application user interface in a Web browser; and
referencing resources for use with the application, the resources referenced with site of origin references that are unique to the application package and agnostic to a file system of the computing device.

10. A computer-implemented method as recited in claim 9, wherein the site of origin references are further agnostic of a URL schema utilized by the Web browser on the computing device to navigate Web content.

11. A computer-implemented method as recited in claim 9, wherein the site of origin references are not dependent on a URL schema supported by a Web server.

12. A computer-implemented method as recited in claim 9, wherein the resources include a local resource that is referenced within the application package on the computing device, and a remote resource that is part of the application package and one of located remote to the computing device or has a different host security basis.

13. A computer-implemented method as recited in claim 9, further comprising utilizing the site of origin references to reference local resources included with the application package on the computing device.

14. A computer-implemented method as recited in claim 9, further comprising utilizing the site of origin references to reference remote resources that are one of located remote to the computing device or are maintained on the computing device and have a different host security basis.

15. A computer-implemented method as recited in claim 9, wherein the application package comprises a site of origin reference scheme that includes the site of origin references, the site of origin reference scheme including:
local site of origin references that are URL compliant to reference local resources included with the application package on the computing device; and
remote site of origin references that are URL compliant to reference remote resources that are part of the application package and one of located remote to the computing device or have a different host security basis.

16. A computer-implemented method as recited in claim 15, wherein:
the local site of origin references are designated ms-wwa:// to reference the local resources on the computing device; and
the remote site of origin references are designated ms-wwa-web:// to reference the remote resources.

17. One or more computer-readable storage media devices comprising instructions that are executable and, responsive to executing the instructions, a computing device:
installs an application package that includes an application authored in a mark-up language and executed from script files;
executes the script files of the application and initiates displaying an application user interface in a Web browser; and
references resources for use with the application, the resources referenced with site of origin references that are unique to the application package, the site of origin references further agnostic to a file system of the computing device and of a URL schema utilized by the Web browser to navigate Web content.

18. One or more computer-readable storage media devices as recited in claim 17, further comprising additional instructions that are executable and, responsive to executing the additional instructions, the computing device utilizes the site of origin references to reference local resources included with the application package on the computing device.

19. One or more computer-readable storage media devices as recited in claim 17, further comprising additional instructions that are executable and, responsive to executing the additional instructions, the computing device utilizes the site of origin references to reference remote resources that are part of the application package and one of located remote to the computing device or have a different host security basis.

20. One or more computer-readable storage media devices as recited in claim 17, further comprising additional instructions that are executable and, responsive to executing the additional instructions, the computing device utilizes a site of origin reference scheme that includes the site of origin references as part of the application package, the site of origin reference scheme including:
local site of origin references that are URL compliant to reference local resources included with the application package on the computing device; and
remote site of origin references that are URL compliant to reference remote resources that are part of the application package and one of located remote to the computing device or have a different host security basis.
